(19) United States
(12) Patent Application Publication
(10) Pub. No.: US 2022/0201146 A1
(43) Pub. Date: Jun. 23, 2022

(54) INFORMATION PROCESSING APPARATUS, INFORMATION PROCESSING SYSTEM, CONTROL METHOD OF THE SAME, AND STORAGE MEDIUM

(71) Applicant: CANON KABUSHIKI KAISHA, Tokyo (JP)

(72) Inventor: Keisuke Ito, Tokyo (JP)

(21) Appl. No.: 17/538,994

(22) Filed: Nov. 30, 2021

(30) Foreign Application Priority Data
Dec. 17, 2020 (JP) 2020-209197

(51) Int. Cl. H04N 1/00; G06V 30/19; G06V 30/14

(52) U.S. Cl. CPC H04N 1/00941; H04N 1/00244; G06V 30/14; H04N 1/00411; G06V 30/19

(57) ABSTRACT

An image processing apparatus for setting a property of a document file by using a result of a character recognition process performed on a scanned image of a document is provided and includes an obtaining unit and an a setting unit. The obtaining unit obtains a character string by performing the character recognition process on a scanned image relating to a document file to be generated in this operation. The setting unit automatically sets the character string obtained by the obtaining unit as a character string to be used in a property of the document file to be generated in this operation if the character string obtained by the obtaining unit is a character string obtained in the character recognition process performed on a scanned image relating to a document file generated in the past and approved by a user a certain number of times or more.

### BACKGROUND OF THE INVENTION

### Field of the Invention

A technique of the present disclosure relates to a technique of setting a property for a document file.

### Description of the Related Art

A method of scanning documents such as paper business forms and converting them to files to store and manage the documents in a storage server on a network has been conventionally widely used. Storing and managing documents in a storage server on a network as document files requires setting of properties such as a file name. For example, as a method of setting the file name, there is a method in which a character recognition process is performed on a scanned image of a document to extract character information and a character string to be used as the file name is selected from the obtained character information.

Moreover, character region information of the character string used by a user to set the file name is stored and accumulated for each type of document. Then, in the case where features of a document form match those of a document stored in the past, the character string used in the past document is automatically proposed as the character string to be used in the file name. In this case, if the character string used for the setting of the file name in the past is incorrect, an incorrect character string is proposed.

In this regard, Japanese Patent Laid-Open No. 2020-46819 discloses a technique that uses a degree of certainty as an index indicating certainty of the character string subjected to the character recognition process and that prompts the user to check or correct the character string subjected to the character recognition process even if the degree of certainty thereof is high.

The aforementioned conventional technique attempts to guarantee the certainty of the character string by making the user check or correct the character string. However, the user may make a mistake in the check or the correction. In such a case, an incorrect character string is set as the file name or the like due to a mistake in the correction or the like made by the user.

A technique of the present disclosure has been developed in view of the aforementioned problems and an object thereof is to allow a user to more easily set characters strings with fewer mistakes as character stings used in properties of document files.

### SUMMARY OF THE INVENTION

The image processing apparatus according to the present disclosure is an image processing apparatus for setting a property of a document file by using a result of a character recognition process performed on a scanned image of a document and includes: at least one memory that stores a program; and at least one processor that executes the program to perform: obtaining a character string by performing the character recognition process on a scanned image relating to a document file to be currently generated; and automatically setting the obtained character string as a character string to be used in a property of the document file to be currently generated in a case where the obtained character string is a character string that is obtained in the character recognition process performed on a scanned image relating to a document file generated in the past and that is approved by a user a certain number of times or more.

Further features of the present disclosure will become apparent from the following description of exemplary embodiments with reference to the attached drawings.

### BRIEF DESCRIPTION OF THE DRAWINGS

FIG. 1 is a diagram illustrating an overall configuration of a system;

FIG. 2 is a hardware configuration diagram of an MFP;

FIG. 3 is a hardware configuration diagram of an MFP cooperative server and a storage server;

FIG. 4 is a software configuration diagram of the system;

FIG. 5 is a diagram showing the relationship of FIGS. 5A and 5B;

FIGS. 5A and 5B are totally a sequence diagram illustrating a flow of processes among apparatuses;

FIG. 6A is a view illustrating an example of a UI screen of a main menu;

FIG. 6B is a view illustrating an example of a login screen;

FIG. 7 is a view illustrating an example of a scan setting screen;

FIG. 8 is a view illustrating an example of a data structure illustrating a result of an analysis process in the system;

FIG. 9 is a view illustrating an example of a file name setting screen;

FIG. 10 is a view illustrating an example of a transmission check screen;

FIG. 11 is a flowchart illustrating details of a character recognition process performed by an image processing unit in the system;

FIG. 12 is a flowchart illustrating details of an automatic transmission determination process performed by the image processing unit in the system;

FIG. 13 is a flowchart illustrating details of a file name setting information storage process performed by the image processing unit in the system;

FIG. 14 is a flowchart illustrating details of the automatic transmission determination process performed by the image processing unit in a second embodiment; and

FIG. 15 is a flowchart illustrating details of the file name setting information storage process performed by the image processing unit in a third embodiment.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

### First Embodiment

### <System Configuration>

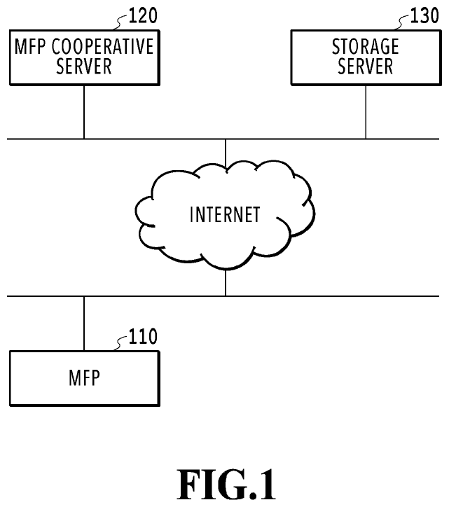

FIG. 1 is a diagram illustrating an overall configuration of an image processing system according to the embodiment. The image processing system includes a multifunction peripheral (MFP) 110 and server apparatuses 120 and 130 that provide a cloud service on the Internet. The MFP 110 is communicably connected to the server apparatuses 120 and 130 via the Internet.

The MFP 110 is an example of an information processing apparatus with a scan function. The MFP 110 is a multifunction peripheral with multiple functions such as a print function and a BOX storage function in addition to the scan function. The server apparatuses 120 and 130 are examples of an information processing apparatus that provides a cloud service. The server apparatus 120 of the embodiment provides a cloud service of performing image analysis on a scanned image received from the MFP 110 and transferring a request from the MFP 110 to the server apparatus 130 that provides another service. In the following description, the cloud service provided by the server apparatus 120 is referred to as “MFP cooperative service”. The server apparatus 130 provides a cloud service of storing a file received via the Internet and providing a stored file in response to a request from a web browser of a client PC (not illustrated) or the like (hereinafter, referred to as “storage service”). In the embodiment, the server apparatus 120 that provides the MFP cooperative service is referred to as “MFP cooperative server” and the server apparatus 130 that provides the storage service is referred to as “storage server”.

The configuration of the image processing system illustrated in FIG. 1 is an example and the present disclosure is not limited to this configuration. For example, the MFP 110 may also have the function of the MFP cooperative server 120. Moreover, the MFP cooperative server 120 may be connected to the MFP 110 via a local area network (LAN) instead of the Internet. Furthermore, the storage server 130 may be replaced by a mail server that performs a mail delivery service and be applied to a situation where a scanned image of a document is sent by being attached to a mail.

### <Hardware Configuration of MFP>

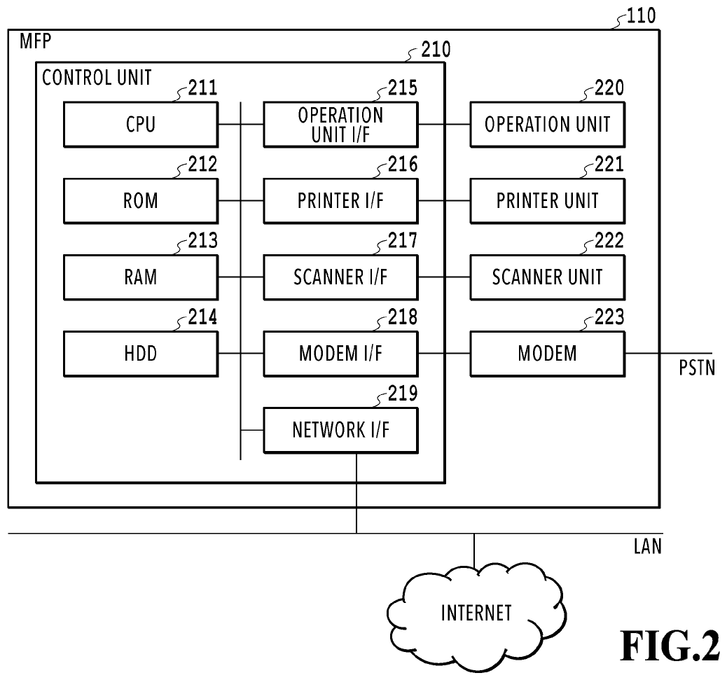

FIG. 2 is a block diagram illustrating a hardware configuration of the MFP 110. The MFP 110 is formed of a control unit 210, an operation unit 220, a printer unit 221, a scanner unit 222, and a modem 223. The control unit 210 is formed of units 211 to 219 to be described below and controls operations of the entire MFP 110. A central processing unit (CPU) 211 reads and executes various control programs (programs corresponding to various functions illustrated in a software configuration diagram to be described later) stored in a read only memory (ROM) 212. A random access memory (RAM) 213 is used as a temporary storage region such as a main memory and a work area of the CPU 211. Although one CPU 211 executes processes illustrated in a flowchart to be described later by using one memory (RAM 213 or a hard disk drive (HDD) 214) in this embodiment, the present disclosure is not limited to this configuration. For example, the processes may be executed by cooperation of multiple CPUs and multiple RAMs or HDDs. The HDD 214 is a high-capacity storage unit that stores image data and the various programs. An operation I/F unit 215 is an interface that connects the operation unit 220 and the control unit 210 to each other. The operation unit 220 includes a touch panel, a keyboard, and the like and receives operations, inputs, and instructions given by a user. Note that a touch operation on the touch panel includes an operation by a human finger and an operation with a touch pen. A printer I/F 216 is an interface that connects the printer unit 221 and the control unit 210 to each other. Image data for printing is transferred from the control unit 210 to the printer unit 221 via the printer I/F 216 and is printed on a recording medium such as paper. A scanner I/F 217 is an interface that connects the scanner unit 222 and the control unit 210 to each other. The scanner unit 222 optically reads an original set on a not-illustrated platen glass or in a not-illustrated auto document feeder (ADF) to generate scanned image data and inputs the scanned image data into the control unit 210 via the scanner I/F 217. The scanned image data generated in the scanner unit 222 can be printed in the printer unit 221 (copy output), stored in the HDD 214, and sent as a file to an external apparatus such as the MFP cooperative server 120 via the LAN. A modem I/F 218 is an interface that connects the modem 223 and the control unit 210 to each other. The modem 223 performs facsimile communication of the image data with a facsimile apparatus (not illustrated) on a public switched telephone network (PSTN). A network I/F 219 is an interface that connects the control unit 210 (MFP 110) to the LAN. The MFP 110 sends the scanned image data to the MFP cooperative server 120 and receives various pieces of data from the MFP cooperative server 120 by using the network I/F 219. The hardware configuration of the MFP 110 described above is an example and the MFP 110 may include other configurations as necessary or may not include some of the configurations.

### <Hardware Configuration of Server Apparatus>

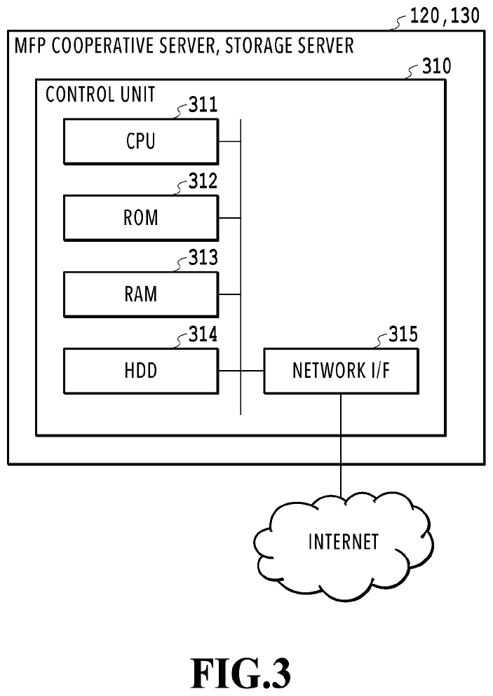

FIG. 3 is a block diagram illustrating a hardware configuration of the MFP cooperative server 120 and the storage server 130. The MFP cooperative server 120 and the storage server 130 have the same hardware configuration and are each formed of a CPU 311, a ROM 312, a RAM 313, a HDD 314, and a network I/F 315. The CPU 311 reads a control program stored in the ROM 312 and executes various processes to control operations of the entire server. The RAM 313 is used as a temporary storage region such as a main memory and a work area of the CPU 311. The HDD 314 is a high-capacity storage unit that stores image data and various programs. The network I/F 315 is an interface that connects a control unit 310 to the Internet. The MFP cooperative server 120 and the storage server 130 receive requests for various processes from other apparatuses (MFP 110 and the like) via the network I/F 315 and send back processing results depending on the requests.

### <Software Configuration of Image Processing System>

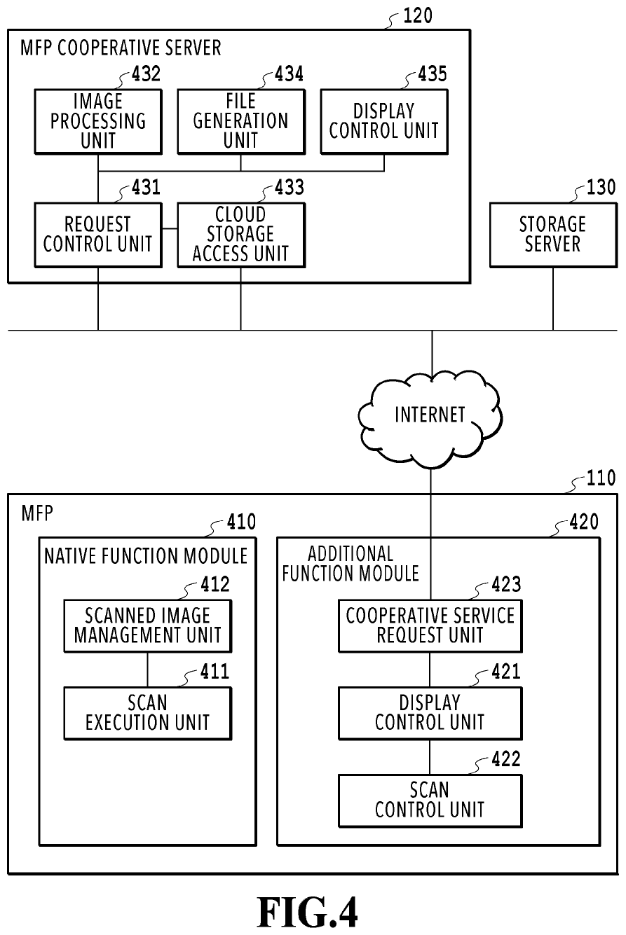

FIG. 4 is a block diagram illustrating software configurations of the image processing system according to the embodiment. Software configurations corresponding to roles of the MFP 110, the MFP cooperative server 120, and the storage server 130 forming the image processing system are described below one by one. Note that description is given below only of functions relating to processes from scanning and computerization (file conversion) of a document to storing of the document in the storage server 130, among various functions of the apparatuses.

### <<Software Configuration of MFP>>

Function modules of the MFP 110 are roughly divided into two modules of a native function module 410 and an additional function module 420. The native function module 410 is an application generally included in the MFP 110 while the additional function module 420 is an application additionally installed into the MFP 110. The additional function module 420 is an application based on Java (registered trademark) and can easily implement addition of functions to the MFP 110. Note that other additional applications that are not illustrated may be installed in the MFP 110.

The native function module 410 includes a scan execution unit 411 and a scanned image management unit 412. Moreover, the additional function module 420 includes a display control unit 421, a scan control unit 422, a cooperative service request unit 423, and an image processing unit (not illustrated).

The display control unit 421 displays a user interface (UI) screen for receiving various user operations on the touch panel of the operation unit 220. The various user operations include, for example, input of login authentication information for access to the MFP cooperative server 120, scan setting, scan start instruction, file name setting, file storage instruction, and the like.

The scan control unit 422 instructs the scan execution unit 411 to execute a scan process while sending information on scan setting thereto, in response to a user operation (for example, pressing of a “scan start” button 701 to be described later) performed on the UI screen. The scan execution unit 411 causes the scanner unit 222 to execute a document read operation via the scanner I/F 217 according to the scan process execution instruction from the scan control unit 422 and generate scanned image data. The scanned image management unit 412 stores the generated scanned image data in the HDD 214. In this case, the scan control unit 422 is notified of information on a scanned image identifier that uniquely indicates the stored scanned image data. The scanned image identifier is a number, a symbol, an alphabet, or the like for uniquely identifying an image scanned in the MFP 110. For example, the scan control unit 422 obtains a scanned image data to be converted to a file from the scanned image management unit 412 by using the aforementioned scanned image identifier. Then, the scan control unit 422 instructs the cooperative service request unit 423 to send a request for processes necessary for file conversion to the MFP cooperative server 120.

The cooperative service request unit 423 sends requests for various processes to the MFP cooperative server 120 and receives responses to these requests. The various processes include, for example, login authentication, analysis of the scanned images, transmission of the scanned image data, and the like. A communication protocol such as representational state transfer (REST), SOAP, or the like is used for communication with the MFP cooperative server 120.

The image processing unit (not illustrated) performs a predetermined image process on the scanned image data and generates an image used in the UI screen displayed by the display control unit 421. Details of the predetermined image process are described later.

Note that an apparatus other than the MFP 110 (not-illustrated client PC or the like) may include the aforementioned additional function module 420. Specifically, the system configuration may be such that the request for analysis of the scanned image obtained in the MFP 110, the setting of a file name based on an analysis result, and the like are performed in the client PC.

### <<Software Configuration of Server Apparatuses>>

First, a software configuration of the MFP cooperative server 120 is described. The MFP cooperative server 120 includes a request control unit 431, an image processing unit 432, a cloud storage access unit 433, a file generation unit 434, and a display control unit 435. The request control unit 431 stands by in a state where it can receive a request from an external apparatus, and instructs the image processing unit 432, the cloud storage access unit 433, and the file generation unit 434 to execute predetermined processes depending on the contents of the received request.

The image processing unit 432 performs image modification processes such as rotation and tilt correction in addition to analysis processes such as a character region detection process, a character recognition process (OCR process), a similar document determination process, and an automatic transmission determination process on the scanned image data sent from the MFP 110.

A character region detected from the scanned image is referred to as “character region” in the following description. Moreover, description is given of an example in which a business form such as a quotation or a sales invoice is a target document, and a scanned image of this document is referred to as “business form image”. The cloud storage access unit 433 sends a request for a process to the storage server 130. In a cloud service, various interfaces for storing a file in a storage server and obtaining a stored file by using a protocol such as REST or SOAP are made open to the public. The cloud storage access unit 433 sends a request to the storage server 130 by using the interfaces made open to the public. The file generation unit 434 receives an instruction from the request control unit 431 and generates a document file including a scanned image. In this case, the file generation unit 434 sets a file name based on a result of a character recognition process performed on a character string included in the scanned image. The display control unit 435 receives a request from a web browser operating on a PC or a mobile terminal (both are not illustrated) connected via the Internet and sends back screen configuration information (HyperText Markup Language (HTML), Cascading Style Sheets (CSS), or the like) necessary for screen display. The user can check registered user information and change the scan setting through a screen displayed on the web browser.

Next, a software configuration of the storage server 130 is described. The storage server 130 includes a request control unit (not illustrated), a file management unit (not illustrated), and a display control unit (not illustrated). The request control unit (not illustrated) stands by in a state where it can receive a request from an external apparatus, and instructs the file management unit (not illustrated) to store a received file or read a stored file in response to a request from the MFP cooperative server 120 in the embodiment. Then, the request control unit (not illustrated) sends back a response depending on the request, to the MFP cooperative server 120. The display control unit (not illustrated) receives a request from a web browser operating on a PC or a mobile terminal (both are not illustrated) connected via the Internet and sends back screen configuration information (HTML, CSS, or the like) necessary for screen display. The user can check and obtain a stored file through a screen displayed on the web browser.

### <Flow of Overall Process>

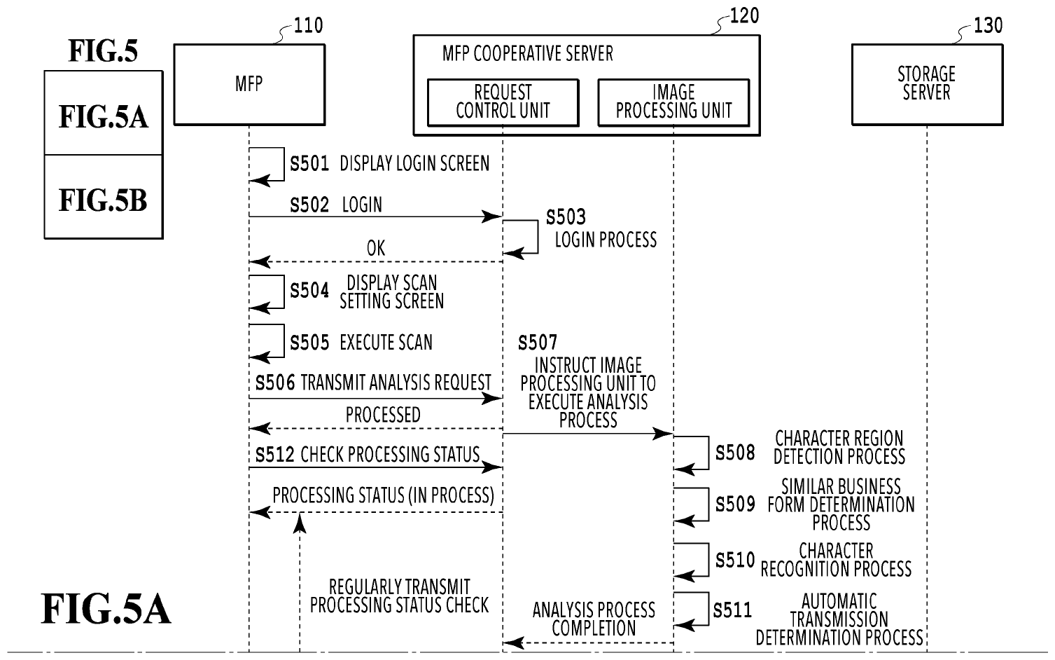

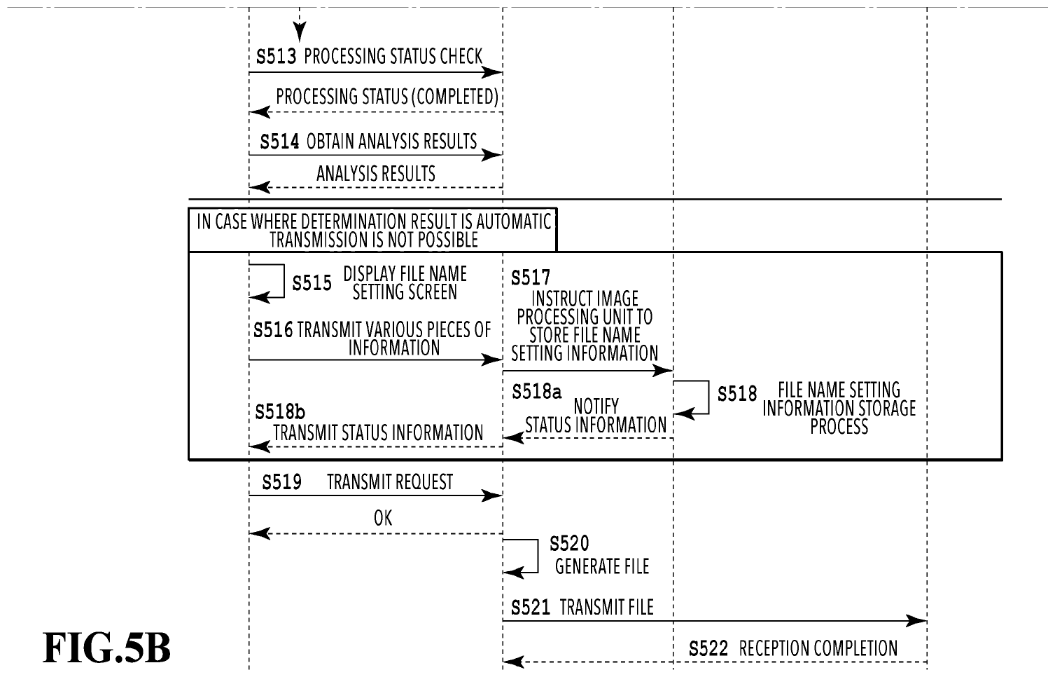

FIGS. 5A and 5B are totally a sequence diagram illustrating a flow of processes among the apparatuses in the case where a document (for example, a business form such as a quotation) is scanned in the MFP 110 and the obtained scanned image (for example, a business form image) is converted to a file and stored in a storage server. Although the sequence diagram of FIGS. 5A and 5B describes the case of setting a file name to be given in the file conversion of a scanned image, the sequence diagram can be applied not only to the file name but also to properties in general such as a folder pass and metadata.

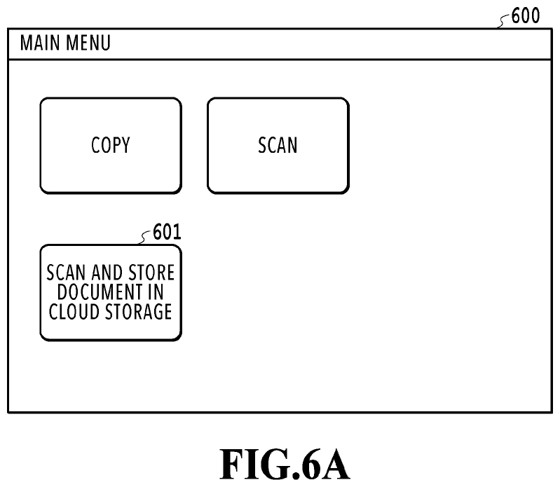

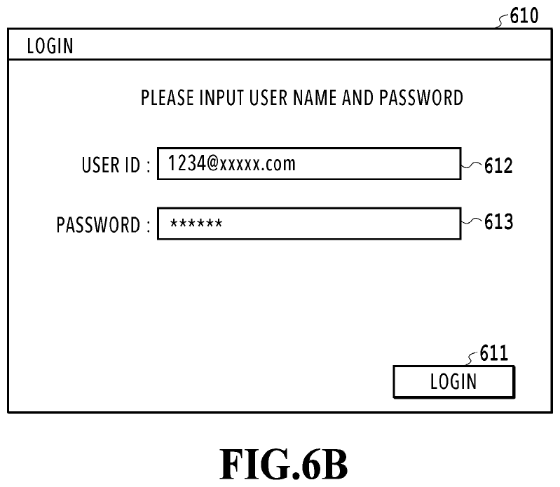

FIG. 6A is a view illustrating an example of an UI screen of a main menu (hereinafter, referred to as “main screen”) displayed at start-up of the MFP 110. A “scan and store document in cloud storage” button 601 is displayed on the main screen 600 by installing a dedicated application necessary for scanning and file conversion of a document and for use of the cloud storage service, in the MFP 110. Then, in the case where the user presses the “scan and store document in cloud storage” button 601 among menu buttons displayed in the main screen 600, the series of processes illustrated in the sequence diagram of FIGS. 5A and 5B starts.

Communications among the apparatuses are described below in a chronological order based on the sequence diagram of FIGS. 5A and 5B. Note that sign “S” in the following description indicate step.

In S501, the MFP 110 displays an UI screen for inputting login authentication information used to access the MFP cooperative server 120 (hereinafter, referred to as “login screen”), on the operation unit 220. FIG. 6B illustrates an example of the login screen 610 displayed on the operation unit 220. As illustrated in FIG. 6B, the login screen 610 includes a “login” button 611, an ID input field 612, and a password input field 613.

In S502, in the case where the user inputs a user ID and a password registered in advance respectively into the ID input field 612 and the password input field 613 on the login screen 610 and presses the “login” button 611, a login authentication request is transmitted to the MFP cooperative server 120.

In S503, the MFP cooperative server 120 having received the login authentication request performs an authentication process by using the user ID and the password included in the request. In the case where the user is confirmed to be a qualified user as a result of the authentication processing, the MFP cooperative server 120 sends back an access token to the MFP 110. Hereinafter, sending this access token together with various requests from the MFP 110 to the MFP cooperative server 120 enables determination of the logging-in user. In the embodiment, login to the storage server 130 is completed simultaneously with the completion of login to the MFP cooperative server 120. To this end, the user ID for using the MFP cooperative service is linked in advance with an user ID for using the storage service via a web browser or the like in a PC (not illustrated) on the Internet. This allows login authentication to the storage server 130 to be completed simultaneously with success of the login authentication to the MFP cooperative server 120 and an operation of login to the storage server 130 can be omitted. Moreover, the MFP cooperative server 120 can handle requests relating to storage services from the user logging into itself. The method of login authentication may be a general, publicly known method (authorization using Basic authentication, Digest authentication, OAuth, or the like).

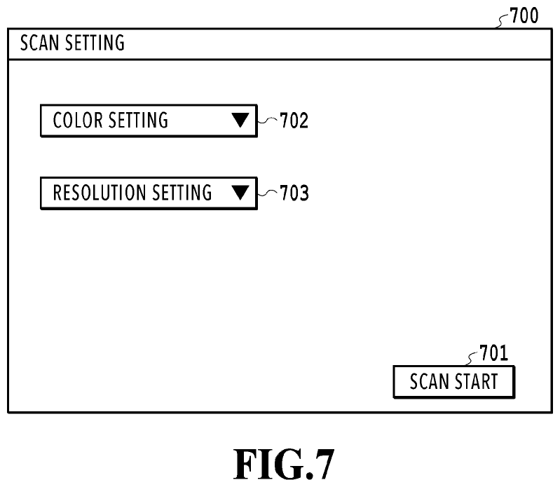

In S504, in the case where the login is completed, a UI screen for scan setting (hereinafter, referred to as “scan setting screen”) is displayed on the operation unit 220 in the MFP 110. FIG. 7 illustrates an example of the scan setting screen. The scan setting screen 700 includes a “scan start” button 701, a color setting field 702, and a resolution setting field 703. The “scan start” button 701 is a button for instructing start of the scan process on a document (assumed to be a business form such as a quotation or a sales invoice in the embodiment) set on a platen glass. A color mode in scanning is set in the color setting field 702. For example, the color mode can be specified from choices such as full color and monochrome. Resolution in scanning is set in the resolution setting field 703. For example, the resolution can be specified from choices such as 600 dpi and 1200 dpi. Note that the color mode and the resolution are examples of setting items and not all of these items have to be present or setting items other than these items may be present. Moreover, the choices relating to the color mode and the resolution may be limited to setting values requested by the storage service. The logging-in user sets detailed conditions for the scan process through such a scan setting screen 700.

In S505, in the case where the logging-in user having completed the scan setting sets a document to be scanned on the glass platen of the MFP 110 and presses the “scan start” button 701, the scan is executed. The scanned image data obtained by computerizing a paper document is thus generated.

In S506, after completion of the scanning, the MFP 110 transmits the scanned image data that is data including an image obtained in this scanning to the MFP cooperative server 120, together with an analysis request that is a request for analyzing the scanned image data.

In S507, in the MFP cooperative server 120 having received the analysis request of the scanned image, the request control unit 431 instructs the image processing unit 432 to execute an analysis process (S508 to S511). In this case, the request control unit 431 sends back a request ID (“processId”) by which the received analysis request can be uniquely determined, to the MFP 110.

In S508, the image processing unit 432 having received the instruction to execute the analysis process executes the analysis process on the scanned image relating to the analysis request. In this analysis process, first, the image processing unit 432 performs a process of detecting character regions present in the scanned image (hereinafter, referred to as “target image”) being a target of the analysis process (character region detection process). For example, a known method such as a method of extracting rectangular regions assumed to be characters from an image binarized by using a certain threshold may be applied to the character region detection.

In S509, the image processing unit 432 performs a process of determining whether image data of a paper document being the target of image analysis is similar to an image of a previously computerized paper document by checking the image data against training data. Examples of the paper document being the target of image analysis include business forms such as a quotation. Moreover, the process of determining whether the image data of the business form being the target of image analysis is similar to the image of the previously computerized business form by checking the image data against the training data is refereed to as “similar business form determination” in the following description as appropriate. In the similar business form determination, there is used arrangement information that is information indicating a position of each of character regions (hereinafter, referred to as “character region” as appropriate) that are regions present in the target image and that are regions including character strings to be targets of a later-described character recognition process, in the target image. Specifically, the image processing unit 432 compares the arrangement information of the target business form image to be currently generated and the arrangement information of a document file images generated in the past images accumulated in the training data and determines whether the arrangements of the character regions are the same or similar. This is based on the fact that, if the arrangements of the character regions are in a same or similar relationship, it is possible to assume that these documents are the business forms of the same type created by using the same document form (business form). The arrangement information of the past business form images used in the similar business form determination is accumulated as the training data in a “training process” to be described later. Although whether the business forms are similar or not is determined based only on the matching degree of the arrangement of the character regions in the embodiment, for example, whether the business forms are similar or not may be determined by determining the type of business form (quotation, sales invoice, or the like) from the result of an OCR process to be described later and also taking information on the obtained type into consideration.

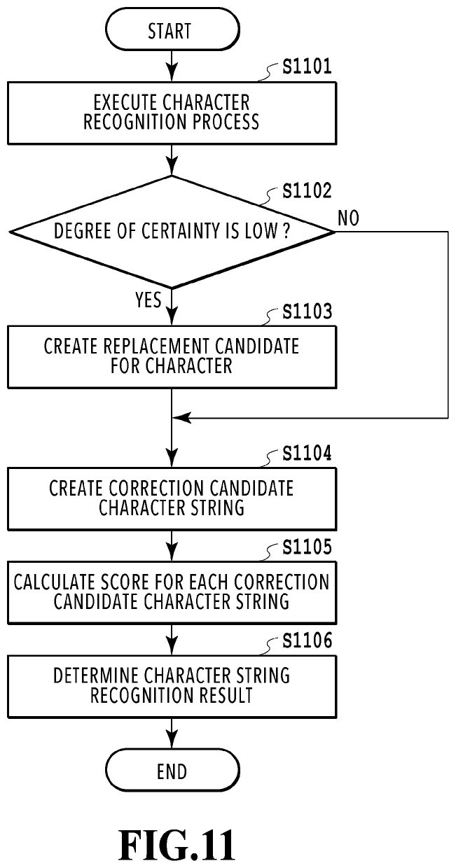

In S510, the image processing unit 432 executes the character recognition process on each of the character regions found in the character region detection process. The character recognition process of the image processing unit 432 in S510 is described later by using FIG. 11.

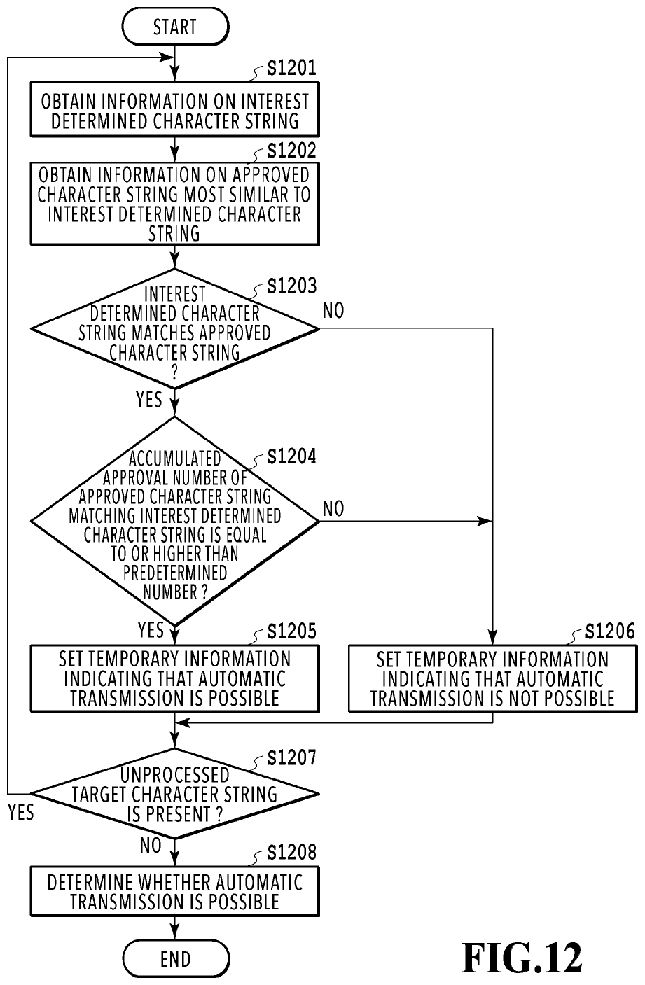

In S511, the image processing unit 432 executes a process of determining whether a document file of the target image in the current operation can be set as a target of automatic transmission (hereinafter, referred to as “automatic transmission determination process”). The automatic transmission determination process is described later by using FIG. 12.

In S512, during the aforementioned analysis process, the MFP 110 regularly (for example, every several hundreds to several milliseconds) checks an analysis process status with the MFP cooperative server 120 by using the aforementioned request ID (S512 to S513). This check is repeatedly performed until the MFP 110 obtains a response including information indicating completion of the analysis process from the MFP cooperative server 120. The request control unit 431 of the MFP cooperative server 120 checks a progress status of the analysis process corresponding to the request ID upon receiving the request for checking of the analysis process status. If the analysis process is not completed, the request control unit 431 sends back an in-process response indicating that that the analysis process is in a status of being currently executed. Meanwhile, if the analysis process is completed, the request control unit 431 sends back a completion response. A character string indicating the current process status is inputted in “status” of these responses. Specifically, in the case where the process is being executed in the MFP cooperative server 120 (in-process response), “processing” is inputted in the “status” and, in the case where the process is completed (completion response), “completed” is inputted in the “status”. Note that character strings indicating other statues such as “failed” used in the case where the process fails may be inputted in the “status”. Moreover, the completion response includes information on URL or the like indicating a storage location of the image analysis results. In the case where the MFP 110 obtains the completion response of the aforementioned analysis process, the MFP 110 transmits a request for obtaining the analysis process results to the MFP cooperative server 120 by using the URL included in the completion response and indicating the storage location of the image analysis result. In the case where the request control unit 431 of the MFP cooperative server 120 receives the request, the request control unit 431 sends back information including the analysis process results (result information) to the MFP 110. In this case, the result information includes a result of the character region determination, a result of the similar business form determination, a result of the character recognition process, and a result of the automatic transmission determination process for the target image.

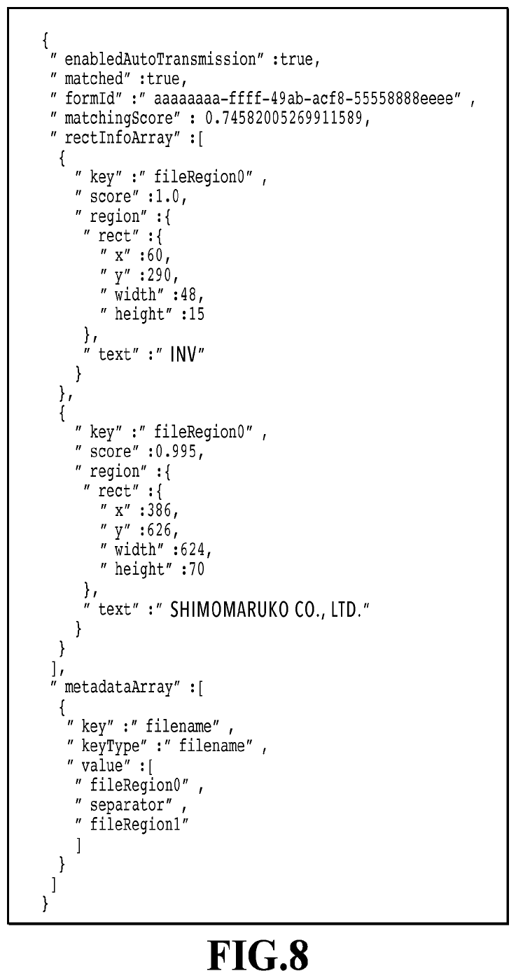

FIG. 8 is a view illustrating an example of a data structure indicating the results of the analysis process. A value (“true” or “false”) determined in the automatic transmission determination process of S511 and indicating whether transmission of the target image to the storage server 130 without user check or training is possible or not is stored in “enabledAutoTransmission”. The client PC (not illustrated) refers to this value and determines whether to automatically transmit the target business form to the storage server 130 based on this value. A value indicating whether a similar business form is found in S509 is stored in “matched”, the similar business form being a scanned image obtained by scanning a business form of a type similar to that of the business form relating to the target image. If the similar business form is present, a value uniquely representing the similar business form is stored in “formId”. Meanwhile, in the case where there is no similar business form, a new value is issued and is stored. If the similar business form is present, a value indicating a degree of similarity is stored in “matchingScore”. The “matchingScore” expresses a degree of matching between the arrangement information of the image scanned in the past and the arrangement information of the image scanned in the current operation, in a real value of 0 to 1. The greater the real value is, the more similar the image scanned in the current operation is to the image scanned in the past. Information indicating a character region that is included in the image being the target of the current analysis and that corresponds to a character region used by the user to set the file name for the similar business form in the past is stored in “rectInfoArray”. For example, assume that, in the past, an image was scanned, the “INV” and “Shimomaruko Co., Ltd.” were used to set the file name, and the input result training was performed. Then, in the case where a new image is scanned and the image scanned in the past is determined to be the similar business form of the new scanned image as a result of the similar business form determination, inputted information is stored as information being a target of automatic input, below the “rectInfoArray”. First, a character region whose coordinate information partially overlaps previously set coordinate information of each of the character regions of “INV” and “Shimomaruko Co., Ltd.” is determined from information stored in the HDD 314 of the MFP cooperative server 120 in the input result training. The coordinate information and characters of a character area that partially overlaps are stored in “rectInfoArray” A value uniquely representing the character region used in automatic input is stored in “key”. A value indicating a degree of certainty that is an index indicating certainty of a result of the character recognition process is stored in “score”. The degree of certainty is expressed in a real value of 0 to 1. The greater the real value is, the more certain the result of the character recognition process is assumed to be. The coordinate information of the character region and characters extracted as a result of performing the character recognition on the character region are stored in “region”. “rect” indicates the coordinates of one extracted character region. “x” indicates an X coordinate of an upper left point of the region, “y” indicates a Y coordinate of the upper left point of the region, “width” indicates the number of pixels in the region in an X direction, and “height” indicates the number of pixels in the region in a Y direction. “text” indicates characters extracted as a result of performing the character recognition process on the character region of “rect”. Information for automatic input of file name that indicates the order of the character regions used in the file name and a position where a separator is inserted is stored in “metadataArray”. In the case where information including properties such as metadata is set in addition to the file name, necessary information is added in “rectInfoArray” and “metadataArray”. A value uniquely representing a set value set for the scanned document is stored in “key”. A value indicating the type of the set value of “key” is stored in “keyType”. In the case where the characters are to be used in the file name, the “key” is set to “filename” and the “keyType” is set to “filename”. Information on the character regions and the separator used in the value of “key” is stored in “value”. In the example of FIG. 8, the file name is automatically inputted in the order of a region having the “key” of “fileRegion0” in the “rectInfoArray”, the separator, and a region having the “key” of “fileRegion1”.

In the case where the result of the automatic transmission determination process is “automatic transmission is not possible”, processes of S515 to S518 to be described later are executed to prompt the user to perform check, correction, or the like. Meanwhile, in the case where the result of the automatic transmission determination process is “automatic transmission is possible”, the processing proceeds to S520 without execution of the processes of S515 to S518 to be described later and the document file of the target image is automatically generated and automatically transmitted to the storage server 130 (S521). In the automatic generation of the document file, the character strings obtained in the character recognition process are used in the file name of this document file.

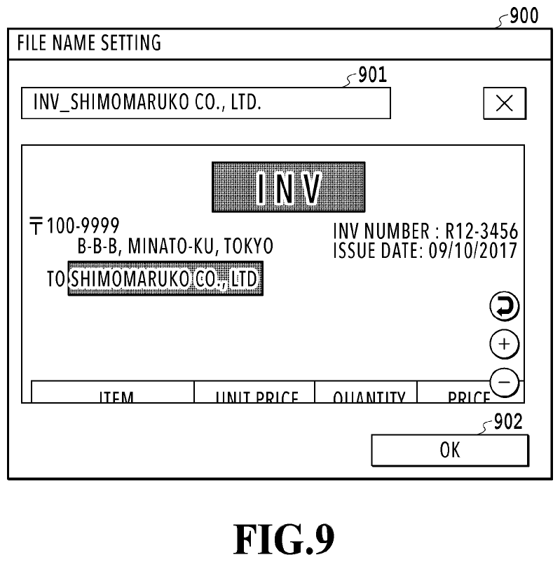

In the case where the result of the automatic transmission determination process is “automatic transmission is not possible”, in S515, the MFP 110 displays a file name setting screen 900 (see FIG. 9) for setting the file name by using the result information obtained in S514. A character string (initial character string) determined to be most certain is inputted in advance in a file name input field 901 of the file name setting screen 900. Specifically, in the case where the accumulated number of times of approval is not satisfied and the automatic transmission is determined not to be performed, a temporary file name using the determined character string at this moment is presented to the user. If there is no error in the character string displayed in the file name input field 901 in this case, the user presses an “OK” button 902 to approve the displayed character string as the file name. Meanwhile, if there is an error in the character string, the user appropriately corrects the character string by manual input and then presses the “OK” button 902.

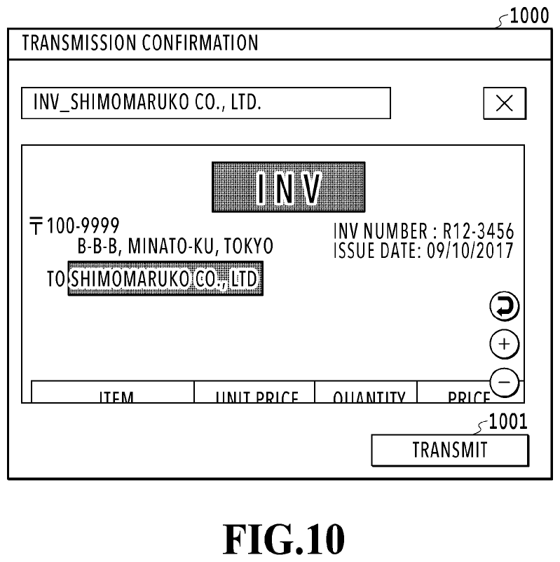

In the case where the MFP 110 detects pressing of the aforementioned “OK” button 902, in S516, the MFP 110 displays a transmission confirmation screen 1000 (see FIG. 10) on the operation unit 220. Then, in the case where the MFP 110 detects pressing of a “transmit” button 1001 by the user, the MFP 110 transmits a request for storing file name setting information to the MFP cooperative server 120. The file name setting information in the case where the determined character string is not corrected includes the character string that is obtained as a result of the character recognition process and that is displayed in the file name input field 901 as the most certain character string. Meanwhile, the file name setting information in the case where the determined character string is corrected includes character region information of this character string and information on the type of the business form in which this character string is written. Moreover, the file name setting information in the case where the determined character string is corrected includes information on the character strings before and after the correction.

In S517, in the case where the request control unit 431 of the MFP cooperative server 120 receives the file name setting information from the MFP 110, the request control unit 431 instructs the image processing unit 432 to store the received file name setting information.

In S518, the image processing unit 432 receives the aforementioned storage instruction from the request control unit 431 and executes a process for storing the file name setting information. Note that details of the process for storing the file name setting information are described later.

In S518a, the image processing unit 432 notifies information including status information indicating completion of the file name setting information storage process to the request control unit 431. In S518b, in the case where the request control unit 431 obtains the information including the status information indicating completion of the storage of the file name setting information from the image processing unit 432, the request control unit 431 transmits a response including the status information indicating this completion to the MFP 110.

In S519, in the case where the MFP 110 obtains the response from the request control unit 431 transmitted in S518, the MFP 110 transmits a request for generating a file (file generation request) to the MFP cooperative server 120 based on information included in the obtained response. In the case where the request control unit 431 of the MFP cooperative server 120 receives the file generation request, the request control unit 431 starts a file generation process and sends back a response including information indicating normal reception of the file generation request, to the MFP 110. The MFP 110 terminates the processing upon receiving the response from the request control unit 431 and returns to the scan setting screen display of S504.

In S520, the MFP cooperative server 120 obtains information on a file format from scan setting registered advance and converts the target image to a file (generates a file) according to the obtained file format. In this case, for an automatically transmitted document file, a character string that is used in a past file conversion process (that is, approved by the user) and that satisfies the accumulated number of times of approval is automatically set as the file name. Meanwhile, for a document file transmitted according to an explicit instruction made by the user, a file name that is created by the user by appropriately correcting the character string presented on the file name setting screen and performing final check is set.

In S521, the request control unit 431 transmits the generated file to the storage server 130. Then, in S522, in the case where the storage server 130 receives the file transmitted from the MFP cooperative server 120, the storage server 130 sends back a response indicating a status of reception completion of this file, to the MFP cooperative server 120.

The rough flow of the processing in the entire image processing system is as described above. Although the contents of the sequence diagram in FIGS. 5A and 5B are such that the MFP 110 communicates with the MFP cooperative server 120, the configuration may be such that the client PC (not illustrated) or the like performs the obtaining of the results of image analysis, the display of the UI screens (for example, the main screen 600 and the like), the training instruction, and the like.

### <Character Recognition Process>

The character recognition process of S510 is described by using FIG. 11. FIG. 11 is a flowchart illustrating a flow of the character recognition process performed by the image processing unit 432 of the MFP cooperative server 120. The CPU 311 executes the processes in this flowchart by loading program codes stored in the ROM 312 and the HDD 314 included in the MFP cooperative server 120 onto the RAM 313 and executing the program codes.

In S1101, the image processing unit 432 executes the character recognition process on the character region obtained in the character region analysis process of S508.

Subsequent S1102 and S1103 are processes performed for each of characters recognized in the character region being the target of the character recognition process.

In S1102, the image processing unit 432 determines whether the degree of certainty is lower than a threshold set in advance, the degree of certainty being the index indicating the certainty of the character obtained as a result of the character recognition process in S1101. In the character recognition process, the image processing unit 432 uses dictionary data in which feature amounts (patterns) of various characters are registered in advance and finds a character whose feature amount matches that of the input character from the dictionary data to recognize a certain character. Accordingly, the higher the feature amount match ratio is, the more accurate the character recognition result is (the more likely the determined character is to be correct). The more blurred or squished the character is, the lower the match ratio tends to be. Accordingly, the feature amount match ratio in the character recognition result is used as the degree of certainty and, if a value of the degree of certainty is low, the image processing unit 432 determines that the input character is a character that requires creation of a character replacement candidate. Meanwhile, if the value of the degree of certainty is high, the image processing unit 432 determines that the input character is a character that does not require the creation of a character replacement candidate. Note that this degree of certainty depends on a used OCR engine. Accordingly, a value of degree of certainty (for example, a predetermined threshold of 95% or more) to be a reference that is obtained through experiments with the used OCR engine is set in advance and the image processing unit 432 determines whether the degree of certainty is high by performing a process of comparing the threshold and the degree of certainty in the character recognition result obtained in S1101. For example, a threshold of 95% or more is set in advance in the image processing unit 432. Then, the image processing unit 432 determines whether the degree of certainty is high by performing the process of comparing the threshold (95% or more) and the degree of certainty (for example, “score” 1.0, in FIG. 8) in the character recognition result for the “N” in the character string “INV” obtained in S1101. In this case, since the degree of certainty in the character recognition result for “N” is “score” 1.0, (that is, 100%) and is higher than the threshold (95% or more), the image processing unit 432 determines that the reliability (that is, degree of certainty) of the character recognition result is high. If the degree of certainty of the character recognition result is lower than the threshold, the processing proceeds to S1103. Meanwhile, if the degree of certainty of the character recognition result is equal to or higher than the threshold, the processing proceeds to S1104.

In S1103, the image processing unit 432 creates a replacement candidate character for a character whose degree of certainty in the character recognition result is determined to be low. For example, in the case where the recognized character is the number “1” and the degree of certainty in the character recognition result is low, other characters with similar shapes such as the lower case alphabet “l” and the upper case alphabet “I” are set as the replacement candidate characters. In this case, characters with character shapes similar to that of the characters recognized in the character recognition process are assumed to be learned by using a publicly known machine learning function.

Processes of S1104 and beyond are processes performed for each character region set as the target of the character recognition process.

In S1104, the image processing unit 432 uses the replacement candidate character created in S1103 to create a correction candidate character string of the character string obtained from the character region. For example, in the case where the initially obtained character sting is “Sales invoice” including the number “1”, the image processing unit 432 creates a correction candidate character string such as “Sales Invoice” in which the number “1” is changed to the upper case alphabet “I”. Moreover, the image processing unit 432 may create a correction candidate character string such as “Sales invoice” in which the number portion is changed to the lower case alphabet “l” in some cases.

In S1105, the image processing unit 432 calculates a score for each correction candidate character string created in S1104. In this case, the image processing unit 432 uses a word dictionary stored in advance and gives a high score to the correction candidate character string in the case where the arrangement of characters matches that of a word in the dictionary. For example, regarding the character string “Sales invoice”, “Sales” matches a word in the word dictionary but “Invoice” does not. In this case, since only one word out of two words matches the word in the word dictionary, the score is 100×1/2=50. Regarding the “Sales Invoice”, “Sales” and “Invoice” both match the words in the word dictionary and the score is thus 100×2/2=100.

Although the example in which the image processing unit 432 calculates the score for the character string of “Sales Invoice” is described as an example of the image processing unit 432 calculating the score for each correction candidate character string, the example of the image processing unit 432 calculating the score for each correction candidate character string is not limited this example. For example, in the case where only the character string “Shimomaruko” in the character string “Shimomaruko Co., Ltd.” is subjected to the character recognition process and the character string “Co., Ltd.” is not recognized at all, “Shimomaruko” matches the word in the word dictionary and the score is thus 100×1/1=100. Then, in S1106 to be described later, the character string “Shimomaruko” is determined as a character string recognition result. However, even in such a case, a negative determination result is likely to be given in determination of S1203 or S1204 to be described later. Moreover, the user visually checks the character string recognition result. Accordingly, the character string “Shimomaruko” is unlikely to be set as the target of automatic transmission.

In S1106, the image processing unit 432 determines the correction candidate character string with the highest score calculated in S1105 as the final character string recognition result. The character string determined as described above is referred to as “determined character string” hereinafter.

The contents of the character recognition process are as described above.

### <Automatic Transmission Determination Process>

The automatic transmission determination process of S511 that is executed subsequent to the character recognition process of S510 is described by using FIG. 12. FIG. 12 is a flowchart illustrating a flow of the automatic transmission determination process. The CPU 311 executes the processes in this flowchart by loading program codes stored in the ROM 312 and the HDD 314 that are storage units included in the MFP cooperative server 120 onto the RAM 313 and executing the program codes. As a prerequisite of the automatic transmission determination process, information (hereinafter, referred to as “past data”) relating to the aforementioned determined character string used in the file name of the document file already stored in the storage is assumed to be held in the HDD 314 of the MFP cooperative server 120 by a process of storing the file name setting information to be described later. For example, assume a case where the file name of the document file to be stored in the storage includes “INV” extracted as the determined character string. In this case, this determined character string is determined to be “approved character string” supposing that the user has approved the use of the character string “INV” as the file name. Then, the number of times the determined character string is determined to be the approved character string is counted and the count number is updated and held in link with the approved character string as an accumulated approval number.

In S1201, the image processing unit 432 obtains information on the determined character string of interest (hereinafter, referred to as interest determined character string) among the determined character strings obtained in the character recognition process. For example, the image processing unit 432 refers to later-described “text” in FIG. 8 saved in the HDD 314 of the MFP cooperative server 120 and obtains the “INV” out of the “INV” and “Shimomaruko Co., Ltd.” as the determined character string of interest.

In S1202, the image processing unit 432 refers to the aforementioned past data and obtains information on the approved character string most similar to the interest determined character string. For example, if the character string “INV” is present in the stored past data as the approved character string, the image processing unit 432 obtains the character string “INV”.

In S1203, the image processing unit 432 performs matching determination of determining whether the interest determined character string obtained in S1201 matches the approved character string obtained in S1202. “Match” described herein is a concept that does not include partial matching. If the interest determined character string matches the approved character string in the result of the determination, the processing proceeds to S1204. Meanwhile, if the interest determined character string does not match the approved character string, the processing proceeds to S1206.

In S1204, the image processing unit 432 refers to the aforementioned past data and determines whether the accumulated approval number of the approved character string matching the interest determined character string is equal to or higher than a predetermined number (equal to or higher than a certain number). In this case, the predetermined number may be set as appropriate depending on a degree at which the user desires to suppress erroneous transmission of a file. For example, in the case where the user places greater priority on the usability than the suppression of erroneous transmission in the automatic transmission of a file, the user may set the predetermined number to a smaller number (for example, 3 or the like). Meanwhile, in the case where the user desires to suppress erroneous transmission as much as possible, the user may set the predetermined number to a greater number (for example, 10 or the like). If the accumulated approval number of the approved character string is equal to or greater than the predetermined number in the result of the determination, the processing proceeds to S1205. Meanwhile, if the accumulated approval number is smaller than the predetermined number, the processing proceeds to S1206.

In S1205, the image processing unit 432 sets temporary information indicating that the automatic transmission is possible, for the interest determined character string. For example, a flag that indicates whether the automatic transmission is possible in a binary value (for example, “1” is given in the case where “automatic transmission is possible” and “0” is given in the case where the “automatic transmission is not possible”) is conceivable as the temporary information.

In S1206, the image processing unit 432 sets, for example, the aforementioned flag as the temporary information indicating that the automatic transmission is not possible, for the interest determined character string.

In S1207, the image processing unit 432 checks whether there is an unprocessed determined character string. If an unprocessed determined character string is left, the processing returns to the process of S1201 and the image processing unit 432 determines the next determined character string of interest and repeats the same processes. If the processing for all determined character strings is completed, the processing proceeds to S1208.

In S1208, the image processing unit 432 determines whether the automatic transmission is possible for the target image of analysis process, based on the aforementioned temporary information given to all determined character strings included the target image. For example, if the temporary information of “automatic transmission is possible” is set for all determined character strings, the image processing unit 432 determines that the automatic transmission of the target image is possible. Alternatively, if a proportion of the determined character strings to which the temporary information of “automatic transmission is possible” is given is equal to or greater than a certain proportion, the image processing unit 432 may determine that the automatic transmission is possible. The image processing unit 432 terminates the processing after this determination.

The contents of the automatic transmission determination process are as described above.

### <Process of Storing File Name Setting Information>

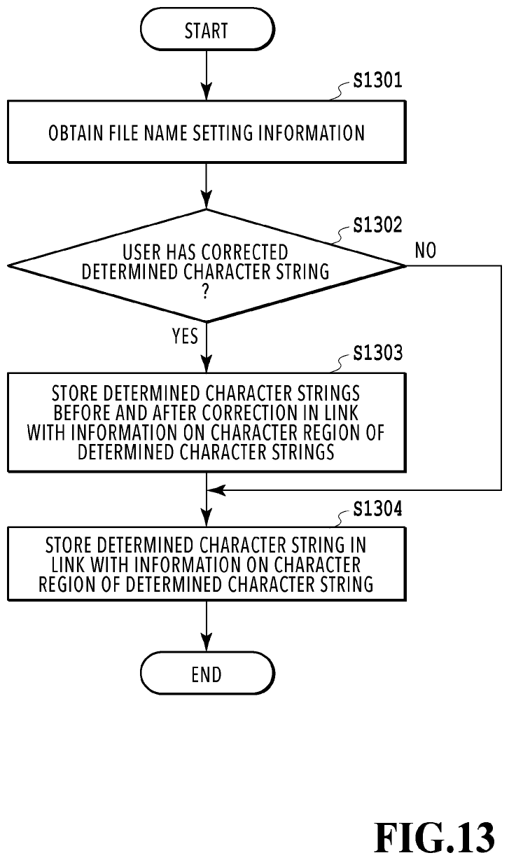

Next, description is given of the process of storing the file name setting information (S518) executed in the case where the automatic transmission is determined not to be possible. FIG. 13 is a flowchart indicating a flow of the process of storing the file name setting information performed by the image processing unit 432 of the MFP cooperative server 120. The CPU 311 executes the processes in this flowchart by loading program codes stored in the ROM 312 and the HDD 314 onto the RAM 313 and executing the program codes. Moreover, the processes of the flowchart are processes executed after the image processing unit 432 of the MFP cooperative server 120 receives an instruction of file name setting information storage from the request control unit 431.

In S1301, the image processing unit 432 obtains the file name setting information from the request control unit 431. As described in S516, the file name setting information includes the pieces of information on the character regions in the target image, the type of business form, and the like, in addition to the determined character strings used in the file name. The pieces of information on the character regions and the type of business form are pieces of information corresponding to “rect” and “formId” in the data structure illustrated in FIG. 8, respectively. For example, for the character string “INV”, the image processing unit 432 obtains information of “x:60, y:290, width:48, height:15” that indicates the character region for the “INV” and information of “aaaaaaaa-ffff-49ab-acf8-55558888eeee” indicating the type of the business form. Note that the steps of S1302 and beyond are executed for each determined character string.

In S1302, the image processing unit 432 determines whether the user has corrected the determined character string, based on information that indicates whether correction for the determined character string is present or absent and that is included in the file name setting information obtained in S1301. The user is assumed to operate the UI screen (for example, software keyboard displayed on the operation unit 220 to correct an erroneously recognized determined character string to a proper character string. This correction also includes, for example, changing the character region used in the file name generated in this operation to a character region different from that used in the initial file name and adding or deleting a separator.

Moreover, the image processing unit 432 performs the aforementioned determination by comparing the value of “value” in “metadataArray” included in the result information with information that is inputted into the file name input field 901 after the file name setting is performed on the scanned image in this operation. If there is a difference in the result of the comparison, the image processing unit 432 determines that the initial file name has been corrected and proceeds to the S1303. If the value matches the information, the image processing unit 432 determines that the initial file name is unchanged and proceeds to S1304. For example, assume a case where, in a character string that should be recognized as “Invoice” in the character recognition process, the upper case alphabet “I” is erroneously recognized as the lower case alphabet “l” and “Invoice” is displayed in the file name input field 901 and is corrected by the user. In this case, since the file name setting information includes information indicating that correction regarding “I” in “Invoice” being the determined character string has been performed, the image processing unit 432 determines that the determined character string has been corrected based on this information. If the user has corrected the character string, the processing proceeds to S1303. If the user has not corrected the character string, the processing proceeds to S1304.

In S1303, the image processing unit 432 stores the character string before the correction (that is the character string erroneously recognized in the character recognition process) and the determined character string after the correction in link with the information on the character region of these character strings. For example, assume a case where the character string before the correction is “invoice” including the lower case alphabet “l” and the corrected determined character string is “Invoice” correctly including the upper case alphabet “I”. In this case, the image processing unit 432 links the “Invoice” before the correction and the “Invoice” after the correction with each other and store these character strings in the storage unit together with the information on the character region of these character strings as “past data”.

In S1304, the image processing unit 432 stores the determined character string in link with the information on the character region thereof. Moreover, the image processing unit 432 checks whether this determined character string is registered as the approved character string. If the determined character string is not registered, the image processing unit 432 counts the accumulated approval number as “1”. If the determined character string is registered, the image processing unit 432 increments (+1) the current count value.

The contents of the process of storing the file name setting information are as described above.

As described above, according to the embodiment, in the case where a result of the OCR process on the file conversion target image has a record of being used in the file name or the like a certain number of times or more in the past, this result is automatically set as the candidate of the file name.

Specifically, in the case where the result satisfies the accumulated approval number and is determined to be automatically transmitted, the determined character string at this moment is used in the file name.

Meanwhile, in the case where the result does not satisfy the accumulated approval number and is determined not to be automatically transmitted, the temporary file name using the determined character string at this moment is presented to the user.

### <Modification Example>

The result of the similar business form determination may be used to determine whether the automatic transmission is possible or not. For example, if the determined character string matches the approved character string and the type of business form relating to the determined character string is the same as the type of business form relating to the approved character string, the certainty of the determined character string is likely to be higher. Accordingly, the following configuration may be employed. In the case where the determined character string approved by the user is stored, the information indicating the type of business form in which this determined character string is written is stored together with the determined character string. Then, in the comparison between the determined character string and the approved character string, the type of business form of the determined character string is compared with the type of business form of the approved character string and the determination of whether the automatic transmission is possible or not based on the accumulated approval number is performed only in the case where the types of business form match each other.

### Second Embodiment

In the first embodiment, a character string that has not been approved in the past or a character string that has been approved but whose number of times of approval is less than the predetermined number is not set as the target of automatic transmission to suppress automatic transmission of a file for which an incorrect file name is set. In this case, even if the degrees of certainty for all characters forming the character string in the result of the character recognition process are values close to “1” (for example, “0.9” or more) and this character string is not corrected by the user, this character string is not set as the target of automatic transmission if the character string is not approved the predetermined number of times or more. Accordingly, the first embodiment has a problem of making the user perform work of approval even though the degree of certainty of the character string is high. The second embodiment solves this problem.

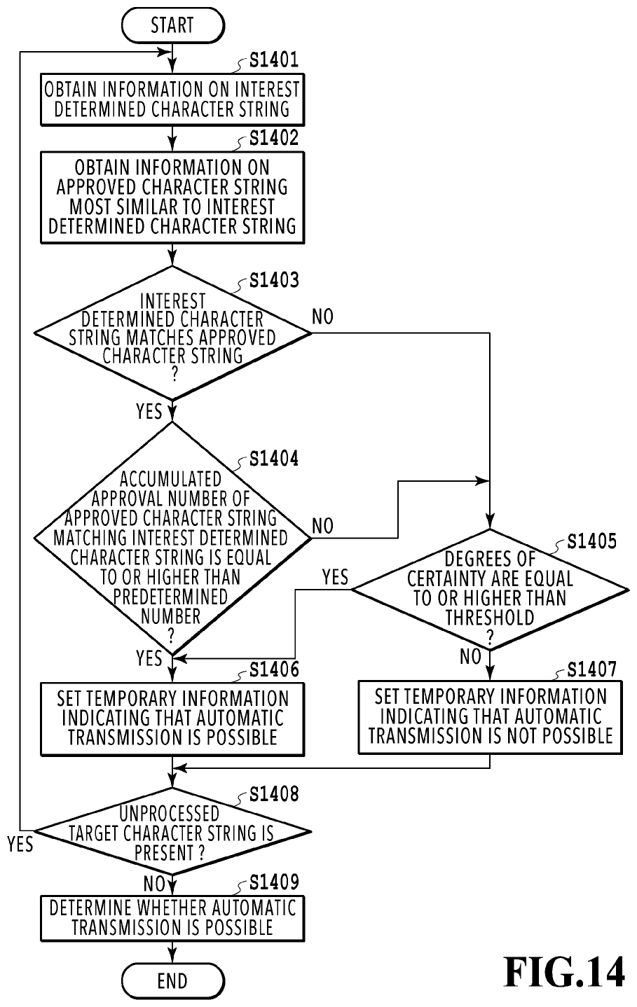

Details of the automatic transmission determination process in the second embodiment are described by using FIG. 14. The CPU 311 executes the processes in this flowchart by loading program codes stored in the ROM 312 and the HDD 314 onto the RAM 313 and executing the program codes. Note that, since a system configuration and a processing procedure in the second embodiment are the same as those described in the first embodiment, description thereof is omitted and only the different points are described.

Since S1401 and S1402 are the same as S1201 and S1202 in the flow of FIG. 12 in the first embodiment, description thereof is omitted.

In S1403, as in S1203, the image processing unit 432 performs the matching determination of whether the interest determined character string matches the approved character string. If the interest determined character string matches the approved character string, the processing proceeds to S1404. Meanwhile, if the interest determined character string does not match the approved character string, the processing proceeds to S1406.

In S1404, as in S1204, the image processing unit 432 determines whether the accumulated approval number of the approved character string matching the interest determined character string is equal to or higher than the predetermined number. If the accumulated approval number is equal to or higher than the predetermined number, the processing proceeds to S1406. Meanwhile, if the accumulated approval number is less than the predetermined number, the processing proceeds to S1405.

In S1405, the image processing unit 432 determines whether the degrees of certainty for all characters forming the interest determined character string are equal to or higher than a threshold set in advance. The degrees of certainty calculated in the already executed flow of FIG. 11 may be used as the degrees of certainty in this case. For example, in the case where the interest determined character string is “INV”, the image processing unit 432 determines whether the degree of certainty for each of three characters of “I”, “N”, and “V” is equal to or higher than the threshold set in advance. The user may set the threshold of the degree of certainty in this case as appropriate depending on a degree at which the user desires to suppress erroneous transmission of a file. For example, in the case where the user places greater priority on the usability than the suppression of erroneous transmission in the automatic transmission of a file, the user may set the threshold of degree of certainty to a smaller value (for example, 0.6 or the like). Meanwhile, in the case where the user desires to suppress erroneous transmission as much as possible, the user may set the threshold of degree of certainty to a greater value (for example, 0.9 or the like). Then, if the degrees of certainty for all characters forming the interest determined character string are equal to or higher than the threshold, the image processing unit 432 determines that the automatic transmission is possible for the interest determined character string. Alternatively, if a proportion of characters whose degrees of certainty are determined to be equal to or higher than the threshold among the characters forming the interest determined character string is equal to or higher than a certain proportion, the image processing unit 432 may determine that the automatic transmission is possible. If the image processing unit 432 determines that the automatic transmission is possible for the interest determined character string in the result of the determination, the processing proceeds to S1406. Meanwhile, if the image processing unit 432 determines that the automatic transmission is not possible for the interest determined character string, the processing proceeds to S1407.

In S1406, as in S1205, the image processing unit 432 sets the temporary information relating to the interest determined character string and indicating that the automatic transmission is possible. Moreover, the image processing unit 432 may additionally set information indicating that the degrees of certainty are equal to or higher than the threshold in the case where the degrees of certainty are equal to or higher than the threshold. An example of the information indicating that the degrees of certainty are equal to or higher than the threshold includes “∞” but is not limited to this.

In the case where the information indicating that the degrees of certainty are equal to or higher than the threshold is additionally set, this information may be set instead of the information relating to the accumulated approval number or may be set together with the information relating to the accumulated approval number.

S1407 corresponds to S1206 in the flow of FIG. 12 and is not particularly different therefrom and description thereof is thus omitted.

S1408 and S1409 also correspond to S1207 and S1208 in the flow of FIG. 12 and are not particularly different therefrom and description thereof is thus omitted.

The contents of the automatic transmission determination process relating to the second embodiment are as described above.

As described above, according to the second embodiment, even if the number of times of approval of the determined character string is less than the predetermined number, the temporary information indicating that the automatic transmission is possible is set as long as the degrees of certainty are equal to or higher than the threshold. This increases the number of document files to be targets of automatic transmission from that in the first embodiment and the work of user approval can be eliminated.

### Third Embodiment

In the first and second embodiments, the automatic transmission of a document file is determined to be possible in the case where the accumulated approval number of a certain character string is equal to or higher than the predetermined number. Meanwhile, users include users who frequently correct the character strings displayed in the file name input field 901 of FIG. 9 and users who rarely correct the character strings. The users who frequently correct the character strings has a higher risk of making correction mistakes than the users who rarely correct the character strings and, as a result, has a higher possibility of approving an incorrect character string. This leads to automatic transmission performed with the incorrect character string used in the file name or the like. Accordingly, in the embodiment, the accumulated approval number that is the reference of the automatic transmission of a file is changed depending on the correction frequency of each user. Specifically, for a user who frequently corrects the character strings, the accumulated approval number necessary for automatically transmitting a file while using a character string approved by the user as a file name is increased.

Note that, since a system configuration and a processing procedure in the third embodiment are the same as those described in the first embodiment, description thereof is omitted and only the different points are described.

### <File Name Setting Information Storage Process>

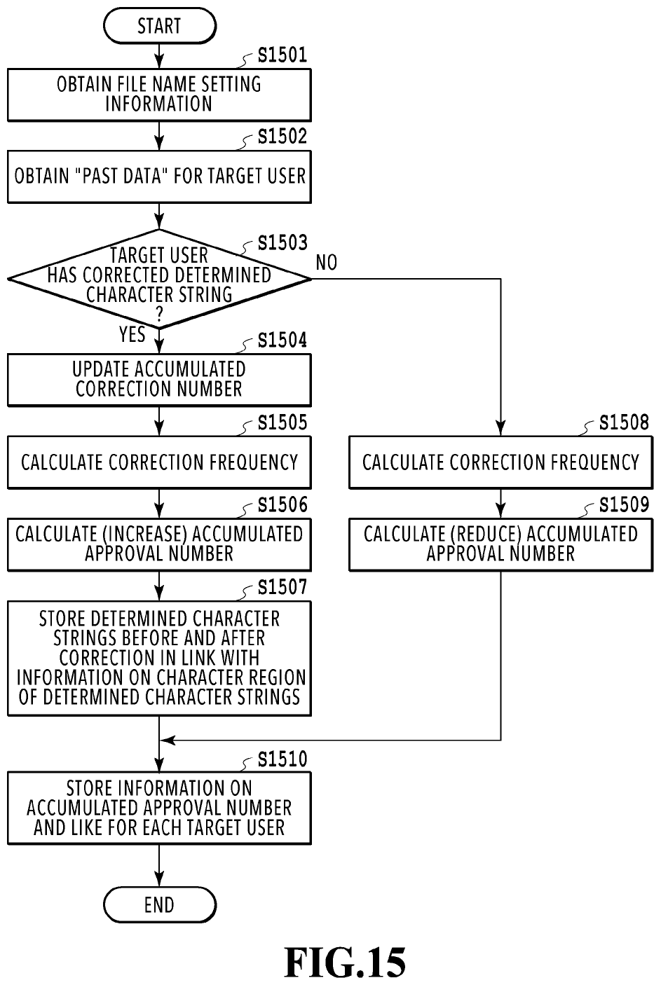

Details of a file name setting information storage process performed by the image processing unit 432 of the MFP cooperative server 120 in the embodiment are described by using FIG. 15. The CPU 311 executes the processes in this flowchart by loading program codes stored in the ROM 312 and the HDD 314 onto the RAM 313 and executing the program codes. In the following description, a user who is a target of a process of counting an accumulated number of times of correction on the determined character string and a process of calculating a frequency of correction on the determined character string is referred to as “target user”. Moreover, the “past data” is assumed to be collected for each target user having created the document file and is held in the storage unit. Specifically, information indicating how many times each character string has been corrected, information indicating how many times each character string has not been corrected, and information indicating a frequency of correcting the determined character string in the case where the document file is stored are held for each user.

In S1501, the image processing unit 432 obtains the file name setting information from the request control unit 431. The file name setting information obtained in the embodiment includes not only the information on the character strings used in the file name and the character regions of the character strings but also information on a user ID identifying the target user and information on presence or absence of correction on the determined character strings made by the target user.

In S1502, the image processing unit 432 obtains the “past data” for the target user. Note that the steps of S1503 and beyond are executed for each determined character string.

In S1503, the image processing unit 432 determines whether the target user has corrected the determined character string. Note that, since the details of the determination in this case are the same as those in S1302 in the flow of FIG. 13 of the first embodiment, description thereof is omitted. If the target user has corrected the determined character string, the processing proceeds to S1504. Meanwhile, if the target user has not corrected the determined character string, the processing proceeds to S1508.

If the target user has corrected the determined character string, in S1504, the image processing unit 432 updates the accumulated number of times the target user has corrected the determined character string (accumulated correction number) by obtaining information indicating that the target user has corrected the determined character string. Moreover, the image processing unit 432 checks whether correction history of this determined character string is registered. If the correction history is not registered, the image processing unit 432 counts the accumulated approval number as “1”. If the correction history is registered, the image processing unit 432 increments (+1) the current accumulated correction number. In S1505, the image processing unit 432 calculates the frequency at which the determined character string is corrected by the target user (hereinafter, referred to as correction frequency) based on the accumulated correction number for the determined character string. In S1506, the image processing unit 432 calculates the accumulated approval number necessary for the automatic transmission performed with the determined character string corrected by the target user used in the file name, based on the calculated correction frequency. S1507 corresponds to S1303 in the flow of FIG. 13 and has no particular difference from S1303. Accordingly, description thereof is omitted.

If the target user has not corrected the determined character string, in S1508, the image processing unit 432 calculates the correction frequency as in S1505. Then, in S1509, the image processing unit 432 calculates the accumulated approval number as a threshold as in S1506.

In S1510, the image processing unit 432 stores the information on the accumulated approval number and the like for each target user. Specifically, the image processing unit 432 stores the accumulated approval number newly calculated and set for each determined character string and the information identifying the target user (user ID) in link with each other as the file name setting information.

The flow of the file name setting information storage process according to the embodiment is as described above.

### <Application Example>

Processes of S1504 and beyond in the case where the target user corrects the determined character string is described by using a specific example.

For example, assume a case where a user A has used a character string “Invoice” 19 times and has performed correction 9 times out of the 19 times in the file name setting information storage process executed in the past. Then, assume that, in the 20th file name setting information process, the user A corrects the character string “Invoice”. The accumulated correction number for the character string “Invoice” for the user A is then incremented and is updated to 10 times (S1504). The correction frequency of the user A in this case can be obtained from, for example, the following formula (1) (S1505).

“Accumulated correction number/(accumulated correction number+number of times correction is not performed)=correction frequency” formula (1).

At this moment, the correction frequency of the user A is (10 times)/(10 times)+(10 times)=0.5 from the aforementioned formula (1).

Then, the accumulated approval number necessary for the automatic transmission performed with the determined character string “Invoice” used in the file name is calculated based on the correction frequency calculated by using the aforementioned formula (1) (S1506). For example, the following formula (2) may be used for the calculation in this case.

“(Correction frequency×10+(accumulated approval number set in advance)=new accumulated approval number” formula (2).

Note that “×10” in the aforementioned formula (2) is a constant for converting the correction frequency expressed in a decimal to an integer. In the case where the correction frequency continues to a second decimal place or beyond, the correction frequency may be rounded down to the nearest tenth.

Assume that the accumulated approval number set in advance is 5 times. Then, the new accumulated approval number in the case where the correction frequency is 0.5 is (0.5)×10+(5 times)=10 times. If the approval number calculated based on the aforementioned formula (2) is not an integer, the approval number may be rounded to the nearest integer. As apparent from the aforementioned formula (2), the “new accumulated approval number” never falls below the “accumulated approval number set in advance”. In other words, the “accumulated approval number set in advance” functions as a minimum value of the approval number necessary for the automatic transmission performed with the determined character string used in the file name. Although the case where the accumulated approval number is changed by being increased is described herein, the present disclosure is not limited to this configuration. For example, the accumulated approval number may be changed such that a value greater than the minimum value is set as an initial value of the “accumulated approval number set in advance” and the accumulated approval number is reduced for a character string approved by a user whose rarely corrects character strings.

According to the embodiment described above, the accumulated approval number can be set as an appropriate threshold depending on the correction frequency of the user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the technique of the present disclosure, the user can more easily set characters strings with fewer mistakes as character stings used in properties of document files.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-209197, filed Dec. 17, 2020 which are hereby incorporated by reference wherein in its entirety.

What is claimed is:

1. An image processing apparatus for setting a property of a document file by using a result of a character recognition process performed on a scanned image of a document, the apparatus comprising:
at least one memory that stores a program; and
at least one processor that executes the program to perform:
obtaining a character string by performing the character recognition process on a scanned image relating to a document file to be currently generated; and
automatically setting the obtained character string as a character string to be used in a property of the document file to be currently generated in a case where the obtained character string is a character string that is obtained in the character recognition process performed on a scanned image relating to a document file generated in the past and that is approved by a user a certain number of times or more.

2. The image processing apparatus according to claim 1, wherein in the automatically setting, the obtained character string is automatically set as the character string to be used in the property of the document file to be currently generated in a case where a format of a document scanned for the document file to be currently generated is the same as a format of a document scanned for the document file generated in the past.

3. The image processing apparatus according to claim 1, wherein in the case where the obtained character string is a character string that is obtained in the character recognition process performed on the scanned image relating to the document file generated in the past but is not the character string approved by the user the certain number of times or more,
automatically setting the obtained character string as the character string to be used in the property of the document file to be currently generated in a case where a degree of certainty being an index indicating certainty of the character recognition process is equal to or higher than a predetermined threshold.

4. The image processing apparatus according to claim 1, wherein the processor executes the program to further perform generating the document file in which the character string automatically set is used in the property.

5. The image processing apparatus according to claim 4, wherein the processor executes the program to further perform automatically transmitting the generated document file to an external apparatus.

6. The image processing apparatus according to claim 1, wherein
the image processing apparatus is connected to an apparatus comprising a display unit that displays a UI screen used by the user to set the property,
in the case where the obtained character string is not approved by the user the certain number of times or more, the character string is displayed on the UI screen as an initial character string of the property.

7. The image processing apparatus according to claim 1, wherein the processor executes the program to further perform changing the certain number of times for an obtained character string based on a frequency of correction on the character string by the user, the obtained character string being presented to the user as the character string to be used in the property of the document file.

8. The image processing apparatus according to claim 1, wherein the property is a file name of the document file.

9. An image processing system comprising:
the image processing apparatus according to claim 1;
an apparatus comprising a display unit that displays the character string to be used in the property of the document file; and
a server apparatus comprising a reception unit that receives the document file.

10. An image processing method of setting a property of a document file by using a result of a character recognition process performed on a scanned image of a document, the method comprising:
an obtaining step of obtaining a character string by performing the character recognition process on a scanned image relating to a document file to be currently generated; and
a setting step of automatically setting the obtained character string in the obtaining step as a character string to be used in a property of the document file to be currently generated in a case where the obtained character string in the obtaining step is a character string that is obtained in the character recognition process performed on a scanned image relating to a document file generated in the past and that is approved by a user a certain number of times or more.

11. A non-transitory computer readable storage medium storing a program for executing a control method that causes a computer to function as an image processing apparatus configured to set a property of a document file by using a result of a character recognition process performed on a scanned image of a document, the control method comprising a control step of causing the computer to function as the image processing apparatus that sets the property of the document file, wherein
a character string is obtained by performing the character recognition process on a scanned image relating to a document file to be currently generated; and
the obtained character string in the obtaining step is automatically set as a character string to be used in a property of the document file to be currently generated in a case where the obtained character string in the obtaining step is a character string that is obtained in the character recognition process performed on a scanned image relating to a document file generated in the past and that is approved by a user a certain number of times or more.
